(19) United States
(12) Patent Application Publication
(10) Pub. No.: US 2023/0192003 A1
(43) Pub. Date: Jun. 22, 2023

(54) Adjustable Roof Assembly for a Vehicle

(71) Applicant: Akash Ladha, Farmington Hills, MI (US)

(72) Inventor: Akash Ladha, Farmington Hills, MI (US)

(21) Appl. No.: 17/552,601

(22) Filed: Dec. 16, 2021

(51) Int. Cl. B60R 9/045

(52) U.S. Cl. CPC B60R 9/045

(57) ABSTRACT

The present disclosure provides a modularly designed assembly for mounting to a vehicle which can be constructed as either a roof basket or a platform, and which is easily adjustable in both length and width by the inclusion of telescoping components throughout the frame. This leads to a versatile structure that easily adjusts to different sizes of vehicles and cargo, as well as adapting to the particular needs of a user.

### FIELD OF INVENTION

The present invention relates generally to vehicle accessories. In particular, the present disclosure relates to a modular and adjustable assembly for fitting to a vehicle as either a platform or basket of a desired size.

### BACKGROUND

There are many existing types of assemblies for utilizing vehicle roofs and truck beds to carry cargo, however due to the varying dimensions of both vehicle and the cargo to be carried, assemblies specific to each different make and model are required. If a user switches between vehicles often this can become costly.

Furthermore, the cargo solutions available on the market are limited in their versatility. In some cases a more basket like assembly is desirable for carrying cargo, in other situations a platform structure is better suited. Thus, at present, vehicle owners are forced to purchase multiple types of assembly for multiple types and sizes of vehicles.

It is within this context that the present invention is provided.

### SUMMARY

The present disclosure provides a modularly designed assembly for mounting to a vehicle which can be constructed as either a roof basket or a platform, and which is easily adjustable in both length and width by the inclusion of telescoping components throughout the frame. This leads to a versatile structure that easily adjusts to different sizes of vehicles and cargo, as well as adapting to the particular needs of a user.

Thus, according to one aspect of the present disclosure there is provided an adjustable modular vehicle basket and/or vehicle platform assembly, comprising: a plurality of telescoping cross railings each comprised of a first portion and a second portion configured to slide and lock in place with respect to the first portion so as to extend or retract to a desired length and lock at a certain extension.

The assembly further comprises a telescoping forward frame railing comprised of a central portion and two outer portions configured to slide and lock in place with respect to the central portion so as to extend or retract to a desired length and lock at a certain extension; a telescoping rearward frame railing comprised of a central portion and two outer portions configured to slide and lock in place with respect to the central portion so as to extend or retract to a desired length and lock at a certain extension; two telescoping side frame elements each comprised of a first portion and a second portion configured to slide and lock in place with respect to the first portion so as to extend or retract to a desired length and lock at a certain extension; and two or more mounting elements.

The opposing ends of each side frame element are affixed to the opposing ends of the front and rearward frame railings to form a rectangular frame, the two or more mounting elements are configured to affix the rectangular frame to a vehicle, and the cross railings are configured to affix to either the bottom of the rectangular frame to form a vehicle basket or the top of the frame to form a platform.

In some embodiments, the assembly further comprises a plurality of locking elements for affixing the opposing ends of each frame element to one another.

In some embodiments, one or more of the telescoping frame elements and cross railings comprise one or more holes along the length of the sliding portions, the extension of the telescoping elements thus being locked by aligning a hole from each sliding portion and affixing them together with a nut and washer assembly.

In some embodiments, the assembly further comprises a reinforcing telescoping top plate configured to adjust to the length of the forward frame railing and affix between the two side frame elements and over the top of the forward frame railing to increase structural integrity.

In some embodiments, the mounting elements are detachable from the assembly and interchangeable with other types of mounting elements specific to different types of vehicle mounts.

### BRIEF DESCRIPTION OF THE DRAWINGS

Various embodiments of the invention are disclosed in the following detailed description and accompanying drawings.

FIG. 1 illustrates an isometric view of an example configuration of a modular assembly according to the present disclosure at a first narrow width and narrow length extension.

FIG. 2 illustrates an isometric view of the example configuration of the modular assembly according to the present disclosure at a second long width and long length extension.

FIG. 3 illustrates a first step in an example assembly process for constructing the disclosed modular assembly with a set of side frame portions being affixed to a set of telescoping cross railings affixed at a certain extension to set the width of the assembly.

FIG. 4 illustrates a second step in an example assembly process for constructing the disclosed modular assembly with a set of second side frame portions being affixed to the set of telescoping cross railings to from telescoping side frame elements affixed at a certain length.

FIG. 5 illustrates a third step in an example assembly process for constructing the disclosed modular assembly with a set of front frame portions being affixed to the cross railings and side frames using a set of locking elements.

FIG. 6 illustrates a fourth step in an example assembly process for constructing the disclosed modular assembly with a set of rear frame portions forming a telescoping rearward frame railing being affixed to the cross railings and opposing ends of the side frames using a set of locking elements.

FIG. 7 illustrates a fifth step in an example assembly process for constructing the disclosed modular assembly with a central portion of the forward frame railing and a guide element being installed to complete the telescoping front frame.

FIG. 8 illustrates a sixth step in an example assembly process for constructing the disclosed modular assembly with a set of top plates being affixed atop the telescoping front frame to secure the structural integrity of the assembly.

FIG. 9 illustrates a seventh step in an example assembly process for constructing the disclosed modular assembly with a set of mounting elements being attached to the undersides of the telescoping cross railings in order to mount the modular assembly to a vehicle roof rack or the like.

FIG. 10 illustrates an isometric view of some example configurations of suitable mounting elements for attaching the modular assembly to different parts of a vehicle and different types of vehicle.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The disclosed modular assembly is beneficial because it provides a cargo solution that can be adapted for different types and sizes of vehicles and cargo, changing width and length according to the required specifications and easily switching between a roof basket and platform, since the entire assembly is modular and held together by nuts and washers so the cross railings can simply be removed from the bottom/top and placed on the opposing side to reform the structure.

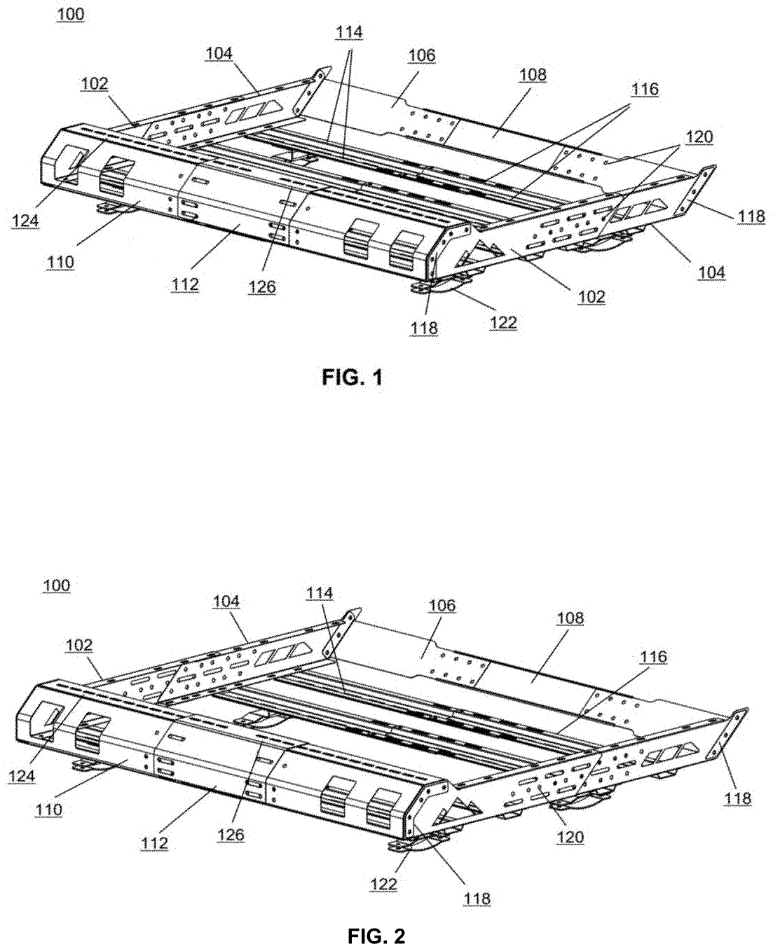

Referring to FIG. 1 and FIG. 2, an isometric view of an example configuration of the modular assembly 100 is shown moving between a first narrow width and narrow length extension (FIG. 1) and a second long width and long length extension (FIG. 2).

The telescoping side frame elements are each formed of a first outer part 102 and a second inner sliding part 104. Telescoping cross railings formed from first portions 114 and second portions 116 are attached to this rectangular frame at the top or bottom to form a basket/platform for a vehicle.

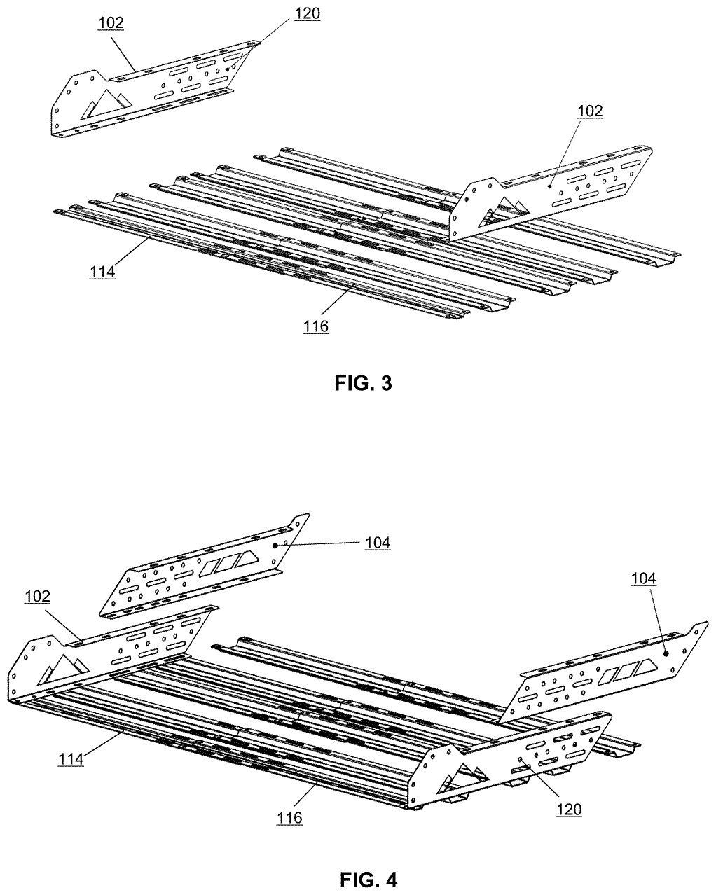

Referring to FIG. 3 and FIG. 4, a first step in an example assembly process for constructing the disclosed modular assembly is shown with the set of side frame portions 102 being affixed to the set of telescoping cross railings formed of portions 114 and 116 that have been affixed at a certain extension to set the width of the entire assembly, a second step then involves set of second side frame portions being affixed to the set of telescoping cross railings to from telescoping side frame elements affixed at a certain length.

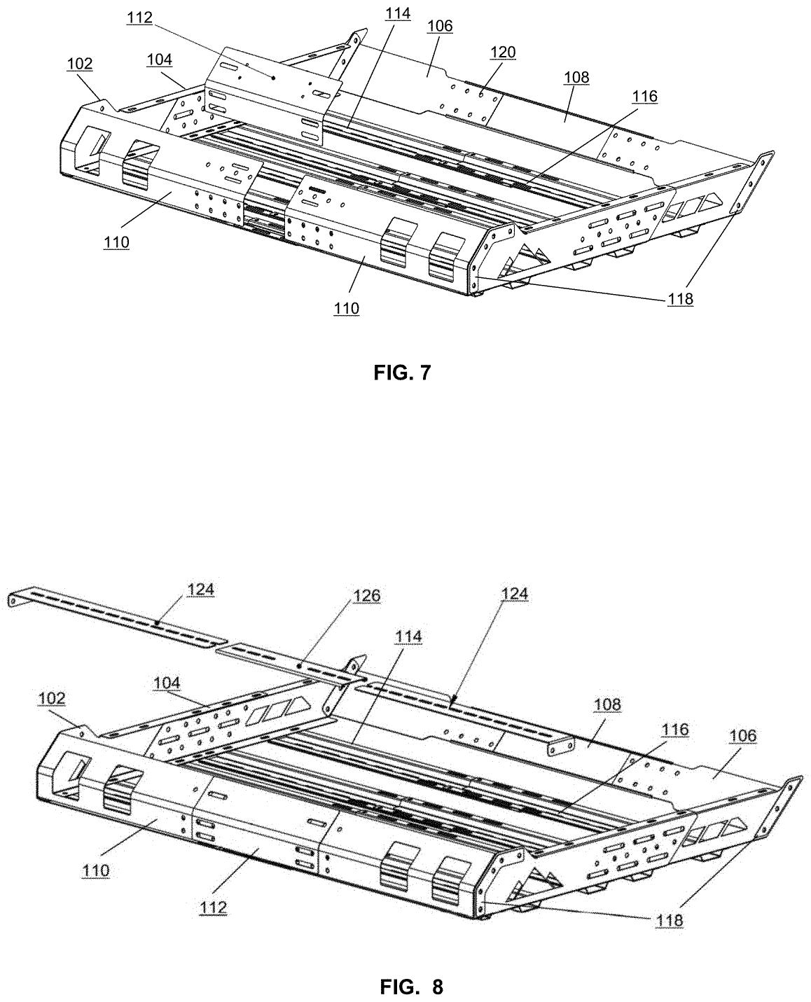

The telescoping rearward frame railing is formed of two side portions 106 that slide into an outer central portion 108. The telescoping forward frame railing is similarly formed from two side frame portions 110 and a central frame portion 112 that has a guiding element 111 (see FIG. 7) affixed to it. Additional locking elements 118 may be used to secure the corners of the rectangular frame.

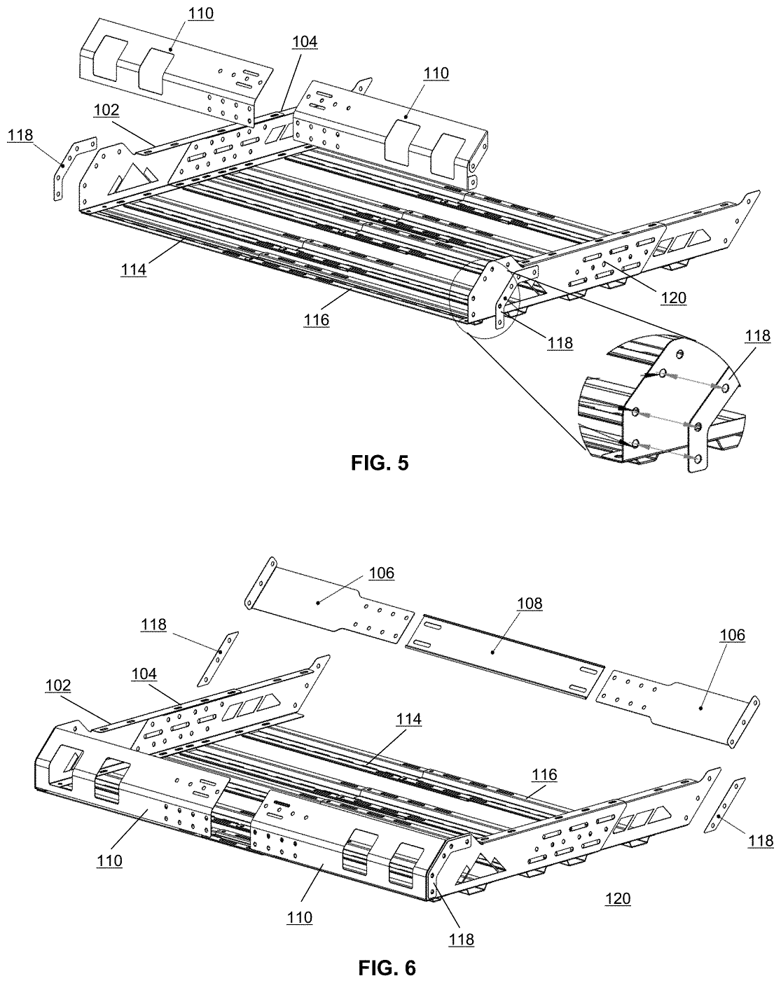

Referring to FIG. 5 and FIG. 6, a third step and fourth step in the example assembly process for constructing the disclosed modular assembly involves a set of front frame portions 110 being affixed to the cross railings and side frames using a set of locking elements 118 and then a set of rear frame portions 106 and 108 forming a telescoping rearward frame railing being affixed to the cross railings 114 and opposing ends of the side frames using a set of locking elements 118.

Together the telescoping frame portions, once affixed at desired lengths, form a rectangular frame of desired size.

The front frame may also be provided with a set of top plates 124 and 126 that secure its structural integrity. This is shown in FIG. 8 which illustrates a sixth step in the example assembly process with a set of top plates 124 and 126 being affixed atop the telescoping front frame to secure the structural integrity of the assembly.

The whole assembly is formed from telescoping elements as described, with the individual pieces usually being thin metal plates with holes 120 spaced along their lengths. Each frame element has at least one outer portion with a slightly larger dimension and an inner portion with a slightly smaller dimension that can slide inside the length of the outer portion.

Both the inner portions and outer portions are provided with holes 120 that align with each other when the portions of the frame are slide against each other, allowing the telescoping frame elements formed by the portions to be affixed at certain lengths, defined by the alignment and placement of the holes, using nuts and washers.

The entire assembly is mounted to a vehicle using set of detachable mounting elements 122 which attach to the cross railings 114 and can be switched out for different types of mounting elements such as mounting elements 128, 130, and 132 shown in FIG. 10.

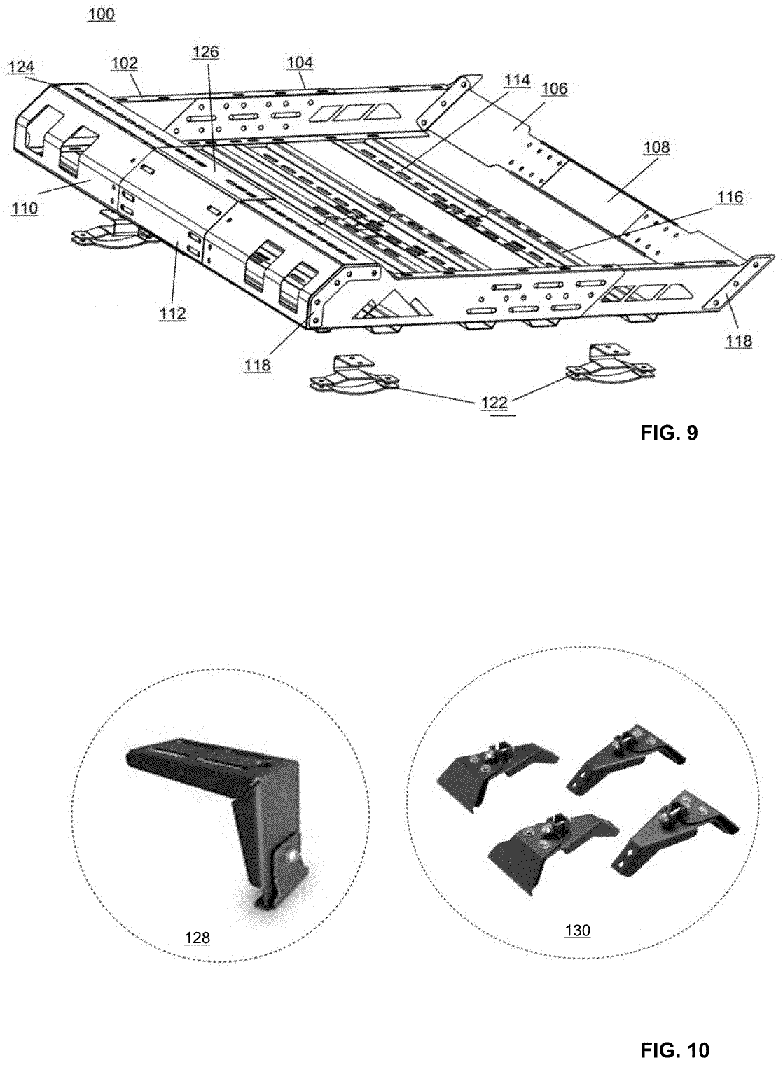

Referring to FIG. 9, a seventh step in the example assembly process is shown with a set of mounting elements 122 being attached to the undersides of the telescoping cross railings 114, 116 in order to mount the modular assembly to a vehicle roof rack or the like.

Referring to FIG. 10, example configurations of suitable mounting elements 128 and 130 are shown for attaching the modular assembly to different parts of a vehicle and different types of vehicle.

It should be noted that many other configurations of mounting elements not illustrated herein could also be suitable for use with the present disclosure.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the modular assembly have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An adjustable modular vehicle assembly, comprising:
a plurality of telescoping cross railings each comprised of a first portion and a second portion configured to slide and lock in place with respect to the first portion so as to extend or retract to a desired length and lock at a certain extension;
a telescoping forward frame railing comprised of a central portion and two outer portions configured to slide and lock in place with respect to the central portion so as to extend or retract to a desired length and lock at a certain extension;
a telescoping rearward frame railing comprised of a central portion and two outer portions configured to slide and lock in place with respect to the central portion so as to extend or retract to a desired length and lock at a certain extension;
two telescoping side frame elements each comprised of a first portion and a second portion configured to slide and lock in place with respect to the first portion so as to extend or retract to a desired length and lock at a certain extension; and
two or more mounting elements;
wherein the opposing ends of each side frame element are affixed to the opposing ends of the front and rearward frame railings to form a rectangular frame, the two or more mounting elements are configured to affix the rectangular frame to a vehicle, and the cross railings are configured to affix to either the bottom of the rectangular frame to form a vehicle basket or the top of the frame to form a platform.

2. An adjustable modular vehicle basket and/or vehicle platform assembly according to claim 1, wherein the assembly further comprises a plurality of locking elements for affixing the opposing ends of each frame element to one another.

3. An adjustable modular vehicle basket and/or vehicle platform assembly according to claim 1, wherein one or more of the telescoping frame elements and cross railings comprise one or more holes along the length of the sliding portions, the extension of the telescoping elements thus being locked by aligning a hole from each sliding portion and affixing them together with a nut and washer assembly.

4. An adjustable modular vehicle basket and/or vehicle platform assembly according to claim 1, wherein the assembly further comprises a reinforcing telescoping top plate configured to adjust to the length of the forward frame railing and affix between the two side frame elements and over the top of the forward frame railing to increase structural integrity.

5. An adjustable modular vehicle basket and/or vehicle platform assembly according to claim 1, wherein the mounting elements are detachable from the assembly and interchangeable with other types of mounting elements specific to different types of vehicle mounts.
